(19) United States
(12) Patent Application Publication
(10) Pub. No.: US 2017/0159530 A1
(43) Pub. Date: Jun. 8, 2017

(54) Method for Producing a Diffusion Blocking Layer on a Metal Plate and an Exhaust Gas Treatment Unit

(71) Applicant: CONTINENTAL AUTOMOTIVE GMBH, Hannover (DE)

(72) Inventor: Dieter Lutz, Meiningen (DE)

(73) Assignee: CONTINENTAL AUTOMOTIVE GMBH, Hannover (DE)

(21) Appl. No.: 15/415,554

(22) Filed: Jan. 25, 2017

Related U.S. Application Data
(63) Continuation of application No. PCT/EP2015/066898, filed on Jul. 23, 2015.

(30) Foreign Application Priority Data
Jul. 25, 2014 (DE) 10 2014 110 534.6

(51) Int. Cl. F01N 3/28; B23K 1/20; C23C 12/02; C23C 24/08; B01D 46/24; C22C 38/18; C22C 38/06; C21D 6/00; B01D 53/92; B23K 1/00; C21D 9/00

(52) U.S. Cl. CPC F01N 3/2842; B23K 1/0014; B23K 1/20; C23C 12/02; C23C 24/082; C21D 9/0068; C22C 38/18; C22C 38/06; C21D 6/002; B01D 53/92; B01D 46/2418; B23K 2201/02

(57) ABSTRACT

The disclosure relates to a method for producing a diffusion blocking layer including aluminum oxide on a metal plate, which consists of a base material containing at least iron (Fe) and chromium (Cr). The aluminum used for forming the aluminum oxide is contained in the base material. A layer made of titanium dioxide serves as an oxygen contributor for the oxidation of the aluminum to a-aluminum oxide. The disclosure further relates to an integration of the method into the production of an exhaust gas treatment unit, where the exhaust gas treatment unit has a honeycomb body and a housing wither of which is formed with a metal plate having a base material that contains at least iron (Fe) and chromium (Cr). According to the disclosure, the metal plate includes a surface layer at least in one sub-region including at least aluminum oxide and titanium oxide.

### CROSS-REFERENCE TO RELATED APPLICATIONS

This application claims the benefit of PCT Application PCT/EP2015/066898, filed Jul. 23, 2015, which claims priority to German Application DE 10 2014 110 534.6, filed Jul. 25, 2014. The disclosures of the above applications are incorporated herein by reference.

### TECHNICAL FIELD

The disclosure relates to a process for producing a diffusion barrier layer on a metal sheet, and also a process for producing an exhaust gas treatment unit and an exhaust gas treatment unit. The disclosure may be directed to the technical field of exhaust gas technology for motor vehicles, and the metal sheet or the exhaust gas treatment unit can be used in an exhaust gas system of a motor vehicle.

### BACKGROUND

Motor vehicles and commercial vehicles are subject to many exhaust gas regulations, adherence to which is ensured by appropriately configured exhaust gas systems. Exhaust gas systems that have at least one exhaust gas treatment unit, which is at least partly formed by a metallic honeycomb body are known. This metallic honeycomb body is used, for example, as support body for catalytically active materials, for coatings for storing exhaust gas components and/or as particle precipitators. The exhaust gas treatment unit is, for this purpose, normally at least partly coated in order to influence or react different constituents of the exhaust gas at different places in the exhaust gas system of a motor vehicle, or to perform other functions for exhaust gas treatment.

Within an at least partly metallic honeycomb body of an exhaust gas treatment unit, soldered connections are produced by means of a high-temperature soldering process so as to achieve fixing of the individual components of the metallic honeycomb body to one another and/or to themselves and/or to achieve durable positioning of the honeycomb body in a housing.

Such metallic honeycomb bodies and housings are formed, for example, by a base material having the following properties: Metal foils of the honeycomb body.

An alloy of the materials group MCrAl, where M is selected from among the elements iron, cobalt, nickel, which can also be entirely or partly replaced by one another, is derived from the metallurgical process and typically contains more than 2.5% by mass of aluminum. According to its chemical composition, this is a ferritic or austenitic steel having a chromium content of at least 12%, frequently also with rare earths, Y and/or Hf to control Al₂O₃ surface layer formation. Commercial examples are FeCrAl alloys having the material numbers 1.4768, 1.4767, 1.4765 and 1.4725 (German steel key).

TABLE 1

| | Chromium | Aluminum | Iron |
|---|---|---|---|
| 1.4765 | ~25 | >4.5 | Balance |
| 1.4768 | ~21 | ~6 | Balance |
| 1.4767 | ~20 | ~5.8 | Balance |
| 1.4725 | ~15 | ~4.2 | Balance |

(Data in % by mass)

Typical material designations here are, for example, Aluchrom, Kanthal and Alkrothal.

It is known that these alloys are able, at appropriate temperatures, to develop oxide surface layers as diffusion barriers by outward diffusion of aluminum and oxidation thereof at the metal surface.

TABLE 2

| | |
|---|---|
| Material thickness: | 20 μm [microns] to 150 μm |
| Form: | at least partially structured; smooth |
| Metal housing | |
| Microstructure: | austenite or ferrite |
| Material thickness: | 0.1 mm [millimeters] to 3 mm |
| Form: | cylindrical; oval; conical |
| Solder material: | |
| Form: | solder powder; solder ribbon |
| Composition: | nickel-based solder, with chromium, phosphorus and |
| | silicon being present as main additives. Very |
| | particular preference is given to the proportions of |
| | the main additives decreasing in the following order: |
| | chromium, phosphorus, silicon. Preference is given |
| | to the chromium content of the nickel-based solder |
| | being above the proportion of chromium in the |
| | material of the honeycomb body, for example in the |
| | range from 23 to 25% by weight. The main additives |
| | phosphorus and silicon should together not exceed |
| | the proportion of chromium. |
| Example of material: | Nickel-based solders of this type are obtainable, for |
| | example, under the name Nicrobraz from Wall |
| | Colmonoy Ltd. |

In the production of an exhaust gas treatment unit, it can be necessary for soldered connections to be provided, or these can be explicitly desired, only at particular contact points between the components (housing, metal sheets, etc.). The soldered connections that are present in (only) locally restricted regions in the honeycomb body and/or between honeycomb body and housing maintain flexibility of the exhaust gas treatment unit in the case of alternating thermal stress (and resulting expansions and shrinkages). This flexibility leads to the exhaust gas treatment unit being able to achieve a higher long-term strength when used in the exhaust gas line of a motor vehicle despite the changing temperatures and pressures prevailing in the exhaust gas system. The desired soldered connections can be produced, for example, by the (targeted) introduction of solder material only at specific contact points of the honeycomb body or the exhaust gas treatment unit. It is also possible here to apply a passivating layer to predetermined regions of the exhaust gas treatment unit so that undesired joins at points of contact are prevented. Here, an undesirable flow of solder material and/or undesirable diffusion of alloying elements from the base material are taken into consideration.

Even though some measures for targeted formation of soldered connections and/or for avoiding undesirable other connections (hereinafter secondary connections, diffusion bonds) at points of contact in the production of such exhaust gas treatment units, which are put together by means of high-temperature soldering under reduced pressure or under protective gas have been proposed, there continues to be a need for this process to be simplified for mass production, to be made reliable, to be able to proceed more inexpensively and/or for further interfering influences on the soldering process to be avoided.

### SUMMARY

Therefore, it is desirable to at least partly solve the tactical problems indicated with respect to the prior art. In particular, it is desirable to have a process for producing a diffusion barrier layer on a metal sheet, which allows particularly precise and defined formation of soldered connections and reduces the risk of later formation of undesirable diffusion bonds on the metal sheet. Furthermore, it is also desirable to have a process for producing an exhaust gas treatment unit in which soldered connections are produced (only) at predetermined places in the exhaust gas treatment unit and undesirable diffusion bonds in the exhaust gas treatment unit are avoided. In addition, it is desirable to have an exhaust gas treatment unit in which soldered connections are produced (only) at predetermined contact points and undesirable diffusion bonds at further contact points can be avoided.

One aspect of the disclosure provides a process for producing a diffusion barrier layer. The diffusion barrier layer is arranged on a metal sheet and including a base material. The base material contains at least iron (Fe) and chromium (Cr). The process includes at least the following steps: a) provisioning the metal sheet; and b) applying at least titanium dioxide as surface layer to at least one subregion of a surface of the metal sheet, where aluminum is already present in the base material and/or aluminum oxide is additionally applied as surface layer. The process also includes c) performing a heat treatment in the context of a high-temperature soldering process above 1050° C. with the metal sheet having the surface layer, so that a diffusion barrier layer including aluminum oxide is formed in the surface layer in the at least one subregion, with simultaneous reduction of the titanium dioxide to form a lower titanium oxide and oxidation of aluminum diffusing out of the base material to form aluminum oxide.

Implementations of the disclosure may include one or more of the following optional features. In some implementations, at least one of titanium dioxide and aluminum oxide is applied in powder form in step b). In some examples, the application as per step b) is carried out using a printing process. The printing process may be pad printing process, screen printing process, or flexographic printing process. In some examples, the surface layer in step b) has a thickness of not more than 0.5 microns.

Another aspect of the disclosure provides a process for producing an exhaust gas treatment unit, where the exhaust gas treatment unit includes a honeycomb body and a housing and at least the honeycomb body or the housing is formed with a metal sheet. The metal sheet consists of a base material containing at least iron (Fe) and chromium (Cr). The process includes at least the following steps: i. provisioning of at least one metal sheet for forming a housing or a honeycomb body, ii. applying of at least titanium dioxide to at least a subregion of a surface as surface layer to at least a subregion of a surface of the metal sheet, where aluminum is already present in the base material and/or aluminum oxide is additionally applied as surface layer, and iii. forming of a honeycomb body and insertion of the honeycomb body into a housing. The process also includes the following steps: iv. soldering application of solder to at least the honeycomb body or the housing in at least one solder section, and v. performing a soldering process above 1050° C. on the at least one metal sheet having the surface layer under reduced pressure or protective gas, so that: a diffusion barrier layer including aluminum oxide is formed only in the at least one subregion in the surface layer with simultaneous reduction of titanium oxide to form a lower titanium oxide and oxidation of aluminum diffusing out from the base material to form aluminum oxide, and a soldered connection on the at least one metal sheet is formed in the at least one solder section.

Implementations of this aspect of the disclosure may include one or more of the following optional features. In some implementations, a coating process by means of which an exhaust gas treatment layer that covers the surface layer in at least one subregion is carried out after step v.

Another aspect of the disclosure provides an exhaust gas treatment unit having a honeycomb body and a housing. At least the honeycomb body or the housing includes a metal sheet and the metal sheet includes of a base material containing at least iron (Fe) and chromium (Cr). The metal sheet has, at least in a subregion, a surface layer that includes at least α-aluminum oxide and lower titanium oxides. An exhaust gas treatment layer completely covers the surface layer at least in the subregion. In addition, a soldered connection is formed in at least a soldering section on the metal sheet at least in the one subregion. This aspect of the disclosure may be used in a motor vehicle having at least one internal combustion engine, an exhaust gas line and the exhaust gas treatment unit.

The details of one or more implementations of the disclosure are set forth in the accompanying drawings and the description below. Other aspects, features, and advantages will be apparent from the description and drawings, and from the claims.

### DESCRIPTION OF DRAWINGS

The disclosure and the broader technical field are illustrated below with the aid of the figures. The figures show examples, but the disclosure is not restricted to these. Identical reference numerals denote identical items. The figures schematically show:

FIG. 1 is a schematic view of a motor vehicle having an exhaust gas treatment unit;

FIG. 2 is a schematic view of a metal sheet as per process step a) or i.;

FIG. 3 is a schematic view of a metal sheet as per process step b) or ii.;

FIG. 4 is a schematic view of a metal sheet as per process step c) or v.;

FIG. 5: is a schematic view of an exhaust gas treatment unit as per process step iii.;

FIG. 6 is a schematic view of an exhaust gas treatment unit as per process step iv.;

FIG. 7 is a schematic view of an exhaust gas treatment unit as per process step v.; and

FIG. 8 is a schematic view of a section of an exhaust gas treatment unit as per process step v.

### DETAILED DESCRIPTION

One aspect of the disclosure provides a process for producing a diffusion barrier layer. The diffusion barrier layer is arranged on a metal sheet consisting of a base material. The base material contains at least iron (Fe) and chromium (Cr). The process includes at least the following steps: a) provisioning the metal sheet; and b) applying at least titanium dioxide as surface layer to at least one subregion of a surface of the metal sheet, where aluminum is already present in the base material and/or aluminum oxide is additionally applied as surface layer. The process also includes c) performing a heat treatment in the context of a high-temperature soldering process above 1050° C. with the metal sheet having the surface layer, so that a diffusion barrier layer including aluminum oxide is formed in the surface layer in the at least one subregion, with simultaneous reduction of the titanium dioxide to form a lower titanium oxide and oxidation of aluminum diffusing out of the base material to form aluminum oxide.

In some examples, the metal sheet (which can also be referred to as a “metallic layer”) is in particular a metal foil having a thickness in the range from 10 μm [microns] and 3 mm [millimeters]. The thickness of the metal sheet is, when used as metal foil for constructing a honeycomb body, preferably in the range from 10 μm to 120 μm; when used as housing, on the other hand, in the range from, for example, 0.4 mm to 3.0 mm. The metal sheet can also have structuring (e.g., corrugations, knobs, embossing, conductive elements, etc.) and/or openings, through-holes, slits, etc. The metal sheet is optionally formed by fine, metallic wires (in the manner of a nonwoven, knitted, woven fabric, etc.) which in each case have a diameter in the range from 5 μm to 100 μm and a length in the range from 30 μm to 10 mm.

Step b) of the process is carried out, for example, by means of a printing process or another suitable deposition process or application process. Here, at least titanium oxide, optionally also aluminum oxide, is applied as surface layer to at least one subregion of a surface of the metal sheet.

The subregion of the surface may concern a (single) contiguous section of the surface or a plurality/multiplicity of (relatively small) sections. In addition, it is possible for the subregion to concern only one side of the surface of the metal sheet. In some examples, very particular preference is given to at least 70% or at least 90% of the surface or even the entire surface of the metal sheet to be provided with the surface layer.

In a step c), a heat treatment is carried out.

In some implementations, if aluminum is already present in the base material of the metal sheet, it diffuses as a result of the heating of the metal sheet in the direction of the surface layer and accumulates there, or penetrates into the surface layer. If aluminum oxide is applied together with the titanium dioxide as surface layer, it is already present there and contributes to a stronger/thicker diffusion barrier layer.

During the heat treatment (high-temperature soldering process), the aluminum diffusing outward from the base material comes into contact with the titanium dioxide layer on the metal surface and extracts part of the oxygen from this layer and utilizes it for aluminum oxide formation according to the following reaction equations:

2Al+3TiO₂=>Al₂O₃+3TiO (1)

and

2Al+6TiO₂=>Al₂O₃+3Ti₂O₃ (2)

Now only titanium monoxide, titanium trioxide and α-aluminum oxide are present as reaction products on the metal sheet surface. The corundum structure of the α-aluminum oxide is densely packed compared to other aluminum oxide structures and therefore acts as a diffusion barrier. As the diffusion barrier layer, it prevents the migration of elements to and from the surface of the material. In addition, α-alumina is the only thermodynamically and thermally stable oxide form of aluminum. The titanium dioxide in the surface layer serves exclusively as oxygen donor.

In some implementations, the heat treatment in step c) is carried out under reduced pressure or a protective gas atmosphere. For example, no oxygen is introduced. In some examples, the reaction during the heat treatment, which leads, with participation of oxygen, to formation of a-aluminum oxide, occurs only with the participation of oxygen which was bound to the titanium dioxide (at least) in the surface layer (and was present in the surface layer) even before the heat treatment.

Small amounts of oxygen may still be present during the heat treatment despite reduced pressure or protective gas atmosphere.

This “residual oxygen” tends to be insufficient to form a (desired and complete) diffusion-impermeable type of aluminum oxide layer on the surface of the metal sheets.

A person skilled in this field will be familiar with these alloying and transformation processes, and will therefore readily be able to comprehend, imitate and control the chemical processes addressed here. In addition, an illustrative example will be given below.

As an example of a suitable heat treatment, it is possible to select an ambient temperature of over 1050° C. [degrees Celsius] and a treatment time in the range from 10 minutes to 60 minutes in a reduced pressure atmosphere. Very particular preference is given to the ambient temperature not exceeding 1200° C. It may be remarked here that the heat treatment can be configured with a plurality of stages.

It should be noted that the desired high-temperature-stable modification of α-Al₂O₃ is formed only above 1050° C.

In some implementations, a cooling phase, which extends over a period of from 15 minutes to 40 minutes, can likewise follow. The heat treatment can, for example, extend over a total time of at least 2 hours, optionally also at least 3 hours.

In further examples of the process, the titanium dioxide is present in a proportion of at least 40% by mass in the surface layer in step b). The titanium dioxide may be present in a proportion of at least 60% by mass and particularly preferably in a proportion of at least 80% by mass. In some examples, the surface layer does not contain any iron (Fe) and/or any chromium (Cr).

In some implementations, the α-aluminum oxide is homogeneously distributed in the surface layer after step c) of the process has been carried out. In this context, “homogeneously” means that the aluminum oxide is distributed uniformly (over the thickness) in the surface layer, for example, with a deviation of no more than 5% by mass. The deviation can, for example, be determined by comparison of the proportions in % by mass found in various measured regions. In some examples, these measured regions each include an area of from 50 to 400 nm², for example 100 nm² [square nanometers], but are not at all tied to this size of the area.

In some implementations, the proportion of lower titanium oxides (Ti₂O₃ and TiO) in the surface layer after step c) has been carried out is at least 5% by mass, for example, at least 10% by mass or at least 20% by mass. This results from the reaction of the aluminum with the titanium dioxide. The aluminum that has diffused from the base material into the surface layer thus extracts part of the oxygen from the titanium dioxide, and lower titanium oxides are therefore formed in the surface layer, but no titanium aluminides.

In the conversion of titanium dioxide into titanium trioxide, about 10% by mass of oxygen is liberated; if this is converted further into titanium monoxide, another 10% is formed, in the case of complete conversion of titanium dioxide into titanium monoxide, a total of about 20% by mass of oxygen is formed and is available for oxidizing the aluminum.

In some implementations, the proportion of aluminum in the base material in step a) of the process is above 2.5% by mass, with, for example, the proportion of aluminum oxide in this surface layer in step b) of the process being able to be controlled via the thickness of the surface layer.

This also opens up the possibility of using alloys that would not form any surface layers, or only unsatisfactory surface layers, due to their only small or absent aluminum content.

In some examples, aluminum is present in the total region of the oxide surface layer after the heat treatment process as per step c) in a proportion in % by mass which exceeds the proportion in % by mass of aluminum in the (total) material of the metal sheet by a factor of at least 2, preferably a factor of at least 3, and is at least 5% by mass.

In some implementations, after step b) has been carried out, the surface layer has a thickness of not more than 3 μm [microns], for example, a thickness of not more than 0.5 μm, preferably not more than 0.25 μm and particularly preferably not more than 0.1 μm.

The solderability of the foil material is influenced by the thickness layer and thus also by the diffusion barrier layer. In some examples, this is comprehensively ensured by the provision of a particularly thin surface layer.

In some implementations, the formation of the diffusion barrier layer prevents diffusion of elements other than aluminum from the base material into the surface layer. In some examples, the diffusion barrier layer (largely) prevents diffusion of other elements into the base material.

In some implementations, at least titanium dioxide or titanium dioxide in combination with aluminum oxide is incorporated as powder into a printing paste and applied in step b). In some examples, the entire surface layer is applied in one step, in powder form or as printing paste, in step b). By means of the printing process, the powder may be fixed partially, selectively or over the entire area on specific sections of the metal sheet.

In some examples, the titanium dioxide and aluminum oxide are used in the form of nanosize oxides in the particle size range from 5 to about 200 nm, since extremely thin layers can be applied in conjunction with a suitable printing process.

In some implementations, the application of the surface layer in step b) is effected by means of one of the following printing processes: screen printing; flexographic printing; and pad printing. These printing processes are known in principle and are therefore only described briefly below.

Flexographic printing is a direct relief printing process. It is a roller rotation printing process in which flexible printing plates that consist, in particular, of photopolymer or rubber and low-viscosity printing ink (e.g. a printing paste) are used. As a relief printing process, the raised regions of the printing form carry the image, while the printing machinery is simple and resembles that of the gravure printing process. The lowest achievable application thicknesses of material are in this case about 100 nm.

Screen printing is a printing process in which the printing ink (e.g., a printing paste) is, for example, pressed by means of a rubber doctor blade through a fine-meshed woven fabric onto the material to be printed. At those places of the woven fabric where no printing ink is to be printed corresponding to the printed image, the mesh openings of the woven fabric are made impermeable to the ink by means of a template. The achievable application thicknesses of material are in this case a few μm.

Pad printing is an indirect gravure process in which the printing ink is transferred by means of an elastic band, for example, a pad made of silicone rubber, from the printing form to the material to be printed (metal sheet). Concave or convex surfaces may also be printed by this means. The application thicknesses of material are in this case about 35 μm.

In some examples, the surface layer is applied by means of screen printing or flexographic printing processes to smooth metal sheets. For the application of surface layers having a low thickness (about 0.1 μm), the flexographic printing process may be used.

In some implementations, the surface layer is applied to structured/corrugated metal sheets by means of the pad printing process.

An advantage of the application of the surface layer by means of a printing process is that a number of types of powder may simultaneously be prepared in a mixture and may be applied in only one printing process. For example, the mixing ratios can also be set very precisely in a printing process.

In some examples, this makes it possible to ultimately influence the thickness of the diffusion barrier layer composed of aluminum oxide by means of a predetermined amount of oxygen in the surface layer (mainly bound in titanium dioxide). Furthermore, in some examples, it is possible for a predetermined proportion of the aluminum required for the diffusion barrier layer to be applied with the aluminum oxide surface layer. As a result, even alloys having a low aluminum content may be provided with protective layers.

Due to the provision of aluminum oxide in the surface layer, it was possible to dispense with aluminum in the base material at least partly (or even completely). As a result, the latitude for the selection of the base material with respect to the alloy composition is significantly greater.

In some implementations, an aluminothermic process (aluminothermy) in which the titanium dioxide is reduced to lower titanium oxides and at the same time the aluminum which has diffused to the surface is oxidized in a redox reaction occurs during the soldering process in step c. (also applies in the following to step v.). This process is strongly exothermic, so that partial surface melting occurs in the region of the surface coating due to the temperatures that are significantly higher for at least part of the time. In some examples, the entire surface layer is bound together as a result of this thermal process.

However, the typical picture of a reaction that occurs suddenly and the high reaction temperature of/up to 2500° C. associated therewith is not obtained. The reason for a slowed reaction of the two reactants aluminum and titanium oxide is the only gradual provision of aluminum which firstly has to be transported by means of diffusion mechanisms from the base alloy to the surface and is therefore available continuously but always only within limits.

Furthermore, a process for producing an exhaust gas treatment unit, where the exhaust gas treatment unit includes a honeycomb body and a housing and at least the honeycomb body or the housing is formed with a metal sheet. The metal sheet consists of a base material containing at least iron (Fe) and chromium (Cr). The process includes at least the following steps: i. provision of at least one metal sheet for forming a housing or a honeycomb body, ii. application of at least titanium dioxide to at least a subregion of a surface as surface layer to at least a subregion of a surface of the metal sheet, where aluminum is already present in the base material and/or aluminum oxide is additionally applied as surface layer, and iii. formation of a honeycomb body and insertion of the honeycomb body into a housing. The process also includes the following steps: iv. soldering application of solder to at least the honeycomb body or the housing in at least one solder section, and v. carrying out of a soldering process above 1050° C. on the at least one metal sheet having the surface layer under reduced pressure or protective gas, so that: a diffusion barrier layer including aluminum oxide is formed only in the at least one subregion in the surface layer with simultaneous reduction of titanium oxide to form a lower titanium oxide and oxidation of aluminum diffusing out from the base material to form aluminum oxide, and a soldered connection on the at least one metal sheet is formed in the at least one solder section.

In particular, what has been said above with respect to the process for producing a diffusion barrier layer on a metal sheet also applies analogously to the process proposed here, and vice versa. What has been said above with respect to steps a) and b) applies in particular to the steps i. and ii. proposed here for the process. Furthermore, what has been said above with respect to step c) applies particularly to the step v. proposed here for the process, with soldered connections being produced in step v. in addition to the heat treatment.

The proposed steps i. to v. of the process proceed, in particular, sequentially in the order proposed here. However, the step iv. may be carried out before and/or simultaneously with the step iii.

In some examples, the metal sheet proposed here for the exhaust gas treatment unit is a high-temperature-resistant metal sheet that is, in particular, suitable for withstanding the temperature changes and dynamic stresses and also the corrosive environment in the exhaust gas system of a motor vehicle in the long term. Temperatures significantly above 800° C. and/or considerable pressure pulses can act on the exhaust gas treatment unit here as a result of the combustion processes in the internal combustion engine of the motor vehicle.

With regard to the base material, preference is given to using an iron material that additionally includes chromium as the main alloying element. The proportion of chromium is, for example, at least a factor of 3 greater than any proportion of aluminum present. In some examples, the proportion of chromium is in the range from 12 to 25% by mass while the proportion of aluminum is in the range from 1 to 7% by mass and preferably in the range from 2.5 to 6% by mass. In addition, it is possible to use base materials that have been mentioned with respect to the metal foil described at the outset and/or the housing.

In some implementations, the surface layer covers (only) the subregions of the metal sheet which after construction of an exhaust gas treatment unit from the metal sheet form contact points with other components of the exhaust gas treatment unit. For example, the surface layer covers only the contact points at which neither a soldered connection nor a diffusion bond is desired, so that no bonding of the components that form contact points with one another in the exhaust gas treatment unit occurs. However, it is also possible for a surface layer to be applied to subregions of or to the entire surface of the metal sheet, so that soldered connections are subsequently arranged thereon. The surface layer should intrinsically be closed, i.e., for example, there should be no significant gaps to the base material of the metal sheet. In particular, the surface layer is not configured as a catalyst layer, particularly not for the reaction of pollutants in an exhaust gas.

The surface layer results in the elements chromium and iron (as main constituent of the base material of the metal sheet) firstly no longer being present at a contact point. It is known that the elements chromium and iron both have a very high affinity to carbon, and when this is available there under soldering conditions, chromium carbide formation (iron-chromium carbide formation) inevitably occurs, and the metal sheets, which are in particular located above one another, form a permanent bond with one another by means of carbide bridge formation.

Oxide layers such as titanium oxide and aluminum oxide shield the base material from the outside, so that the elements chromium and iron are no longer reached by the carbon-containing atmosphere and iron-chromium carbide formation is also no longer possible.

Without the surface layer proposed here, there is a significant risk of formation of firmly adhering chromium carbide bridges (secondary connection, diffusion bonding) at the contact surfaces of the metal sheet with other components of the exhaust gas treatment unit or with itself during the heat treatment of the steps c) and v. under a corresponding (furnace) atmosphere, depending on the local supply of carbon during the soldering process. Thus, a three-dimensionally finely distributed carbide skeleton is formed under unfavorable circumstances. This carbide skeleton connects/welds the metal sheet firmly to itself and/or to other components of the exhaust gas treatment unit and thus adversely influences the desired flexibility of the arrangement of the metal sheet, for example, in an exhaust gas treatment unit, i.e., the flexibility of the exhaust gas treatment unit itself. Application of a surface layer that separates off the chromium or the iron thus interrupts or inhibits the mechanism of chromium carbide formation. This is explained below.

In some examples, the amount of oxygen necessary for production of the high-temperature-resistant and corrosion-resistant aluminum oxide layer is made available (exclusively) by the application of titanium dioxide as surface layer. It can be ensured in this way that the protective α-aluminum oxide layer is formed on the metal sheet as early as during the soldering process (which is, in particular, carried out under protective gas or under reduced pressure, i.e. without oxygen). Thus, a possible additional subsequent oxidation process for the exhaust gas treatment unit, in particular, is thus dispensed with. This oxidation process usually produces a corresponding aluminum oxide layer on the exhaust gas treatment unit by treatment of the exhaust gas treatment unit at temperatures above 650° C. in an oxygen-containing atmosphere.

In some implementations, the provision of the titanium dioxide in the surface layer results in an appropriate aluminum oxide layer being provided (only) at predetermined subregions of the metal sheet or of the exhaust gas treatment unit as early as during the soldering process.

Components such as metal foils and housings to be joined by soldering can have residues of carbon-containing liquids such as rolling oil or corrugating oil. Due to capillary effects, these liquids are drawn back into the interstices, for example, between corrugated and smooth layers of a honeycomb body, and thus wet these components. After introduction into the soldering plant, evacuation or introduction of a protective gas is commenced. At the same time, the temperature is increased. Combustion of the liquids is no longer possible after the flash point has been attained because of the lack of oxygen, so that above about 400° C. and above a cracking process occurs and results in formation of pure, highly reactive carbon. This cracking process also takes place when producing the soldered connections under protective gas, since the oxygen is also displaced here and carbon-containing manufacturing auxiliaries are cracked. The carbon withdraws the chromium from the components and permanently joins superposed surfaces (which form contact points) of components via carbide bridges due to formation of chromium carbides or iron-chromium carbides (M₂₃C₆). These carbide bridges can no longer be broken even at the highest process temperatures (for producing soldered connections in the honeycomb body). In addition, the alloy of the base material of the components now has a chromium deficit and thus there is a risk of intermetallic corrosion due to the damage.

In the critical temperature range from about 400° C. to 800° C., in which the chromium carbides are formed, the aluminum already diffuses from the base material into the surface layer. In the surface layer or at the surface of the metal sheet, the aluminum that has diffused into the surface layer accordingly reacts with the titanium dioxide. In the course of a redox reaction, the aluminum then oxidizes there by extracting oxygen from the titanium dioxide. Due to the high temperature of the aluminothermic reaction, the thermally stable and diffusion-impermeable a-aluminum oxide phase is formed. The formation of the aluminum oxide layer in this region forms a diffusion barrier layer, so that the alloy constituent chromium and also the iron cannot diffuse out of the base material of the metal sheet and into the surface layer. The alloy constituent chromium or the iron is retained and/or covered in the metal sheet by the diffusion barrier layer, so that chromium carbide bridge formation (e.g., at the contact points with adjacent components) does not occur.

In some examples, the applied surface layer prevents direct contact of carbon with the elements chromium and iron of the base material of the metal sheet. Any undesirable joining of the surfaces of adjacent components therefore does not occur. Accordingly, it is possible to produce an exhaust gas treatment unit in which the connections between the components are formed only at the desired contact points of the surfaces with one another that have been provided with solder. It is thus possible, for example, to prevent different coefficients of expansion of the individual components of an exhaust gas treatment unit from leading to failure of the connection between these components as a result of locally different length changes. These can be compensated for by components that are partially freely movable relative to one another. Furthermore, the vibration behavior of the components of the exhaust gas treatment unit can be set precisely.

In some implementations of the process, a coating process by means of which an exhaust gas treatment layer which generally completely covers the surface layer in the at least one subregion is additionally carried out after step v. For example, this exhaust gas treatment layer serves (exclusively) to treat the exhaust gases conveyed through the exhaust gas treatment unit. The exhaust gas treatment layer can, for example, include a zeolite layer and/or a (porous) washcoat layer. As washcoat, use is made of, for example, the highly porous γ-aluminum oxide but not the diffusion-impermeable α-aluminum oxide. The applied surface layer accordingly makes (in principle) no (appreciable) contribution to the reaction of pollutants in the exhaust gas since it is firstly covered by the washcoat and secondly also does not have the then desired high surface porosity for multiplying the conversion performance.

Another aspect of the disclosure provides an exhaust gas treatment unit, for example, produced by the process of the disclosure and/or having at least one metal sheet produced by the process of the disclosure for producing a diffusion barrier layer.

The exhaust gas treatment unit has at least one honeycomb body and a housing, where at least the honeycomb body or the housing includes a metal sheet and the metal sheet consists of a base material containing at least iron (Fe) and chromium (Cr). The metal sheet has, at least in a subregion, a surface layer that includes: at least α-aluminum oxide and lower titanium oxides (in particular exclusively Ti₂O₃ and/or TiO); an exhaust gas treatment layer completely covers the surface layer at least in the subregion; and a soldered connection is formed in at least a solder section on the metal sheet at least in the one subregion.

In some examples, what has been said regarding the process of the disclosure applies in full to the exhaust gas treatment unit of the disclosure indicated here.

Furthermore, a printing paste that can be used for producing a surface layer in the processes according to the disclosure is proposed, with the printing paste containing at least titanium dioxide. In some examples, it is proposed that the printing paste additionally contains at least aluminum oxide. In some examples, the printing paste includes at least one of the following constituents: a suitable solvent, a suitable dispersant for mixing the various printing paste constituents, and a suitable thixotropicizing agent for setting the printing paste viscosity.

The liquid component of the printing paste may be vaporized by means of a heat treatment after application of the surface layer, so that the thickness of the applied surface layer is reduced and the surface layer hardens. If this does not occur or occurs only insufficiently, not only the titanium monoxide but also the isostructural titanium carbide (“isostructural” means the same lattice structure) can be incorporated into the diffusion barrier layer, but without functionally restricting the diffusion barrier action. The metal sheets or components provided with the printing paste can be passed to a (further) heat treatment as per step c) and v. of the process of the disclosure.

In some examples, what has been said regarding the processes of the disclosure and with respect to the exhaust gas treatment unit of the disclosure applies fully to the printing paste proposed here.

Furthermore, a motor vehicle having at least one internal combustion engine, an exhaust gas line and an exhaust gas treatment unit according to the disclosure is proposed. The exhaust gas treatment unit has been produced by the process of the disclosure or has at least one metal sheet produced by the process of the disclosure for producing a diffusion barrier layer.

The applied surface layer includes at least titanium dioxide which serves, in particular exclusively, to provide oxygen for forming a diffusion barrier layer composed of α-aluminum oxide and to suppress chromium carbide bridges at the contact points. It is, in particular, not provided for nor suitable for forming, e.g., by oxide formation, a catalytically active substance for exhaust gas purification. In the honeycomb body used as exhaust gas treatment unit, the titanium dioxide used has thus already been completely reacted and forms the diffusion barrier layer composed of a-aluminum oxide (and titanium suboxides).

A catalytically active substance for exhaust gas purification is, in the case of the exhaust gas treatment unit described here, provided instead by provision of an exhaust gas treatment layer, which optionally has an appropriate catalytic activity and/or has appropriate properties (conversion, incorporation, storage of exhaust gas constituents), applied to (at least parts of) the surface layer. It is thus particularly desirable for the surface layer itself not to be in contact with the exhaust gas during use. The same applies to the titanium suboxides remaining on the diffusion barrier layer.

It is particularly advantageous for the exhaust gas treatment layer to cover the surface layer (virtually) completely and be gastight to such an extent that the surface layer is not in contact with an exhaust gas during use in the exhaust gas treatment unit. Here, “gastight” means that constituents of the exhaust gas cannot penetrate through the exhaust gas treatment layer to the surface layer so that a catalytic reaction between the surface layer (=diffusion barrier layer and the titanium suboxides) does not occur (to an appreciable extent).

In some implementations, the exhaust gas treatment layer on the exhaust gas treatment unit includes at least a washcoat. A washcoat typically includes at least one refractory oxide support, for example, activated highly porous aluminum oxide (γ-Al₂O₃), and one or more platinum group metal components, for example, platinum, palladium, rhodium, ruthenium and/or iridium. Further additives such as promoters and washcoat stabilizers are often also added. In some examples, the washcoat provides a particularly good contact surface for the exhaust gas. This washcoat may be applied as exhaust gas treatment layer to (at least part of) the exhaust gas treatment unit only after assembly to form an exhaust gas treatment unit, i.e., after formation of the soldered connections by means of a soldering process under reduced pressure or protective gas.

It should here be pointed out once again that what has been said above with respect to the individual subjects of the present disclosure can in each case also be applied to the other subjects and can be combined with one another.

Working example of the production of a diffusion barrier layer:

TABLE 3
Step a)

| | |
|---|---|
| Material of the base material: | DIN material no. 1.4725 |
| Sheet thickness of the metal sheet: | 50 μm [microns] |

Step b)

| | |
|---|---|
| Material of the metal oxide: | Submicron titanium dioxide |
| Thickness of the surface layer: | 0.1 μm |
| Application method: | Flexographic printing |

Step v

| | |
|---|---|
| Type/environment of the heat treatment: | Reduced pressure, |
| Temperature profile of the heat | Stepwise heating to the liquidus |
| treatment: | temperature of the solder |
| Duration of the heat treatment: | A plurality of hours |

Result:
Thickness of the diffusion barrier layer: About 0.1 μm

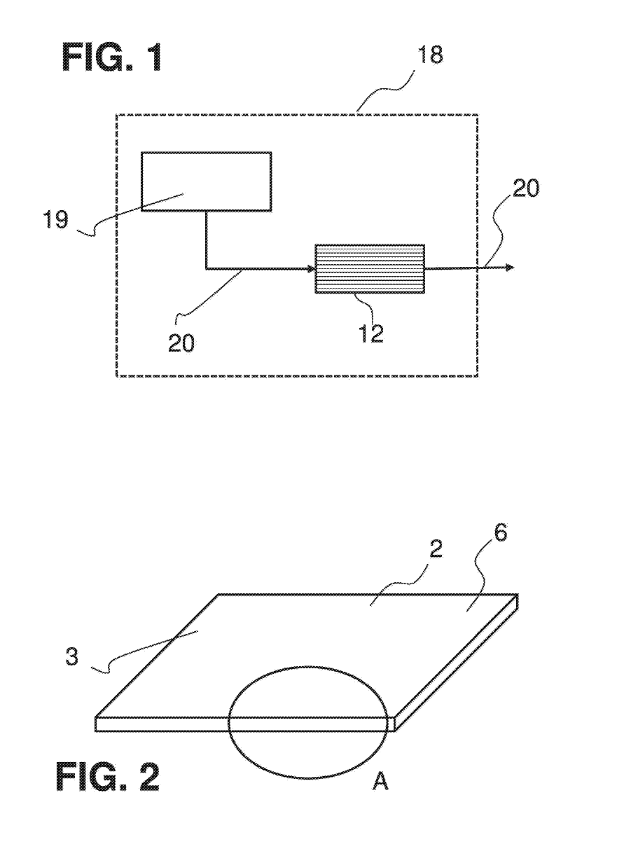

FIG. 1 shows a motor vehicle 18 having an internal combustion engine 19 and an exhaust gas treatment unit 12 that is arranged in an exhaust gas line 20 of the internal combustion engine 19.

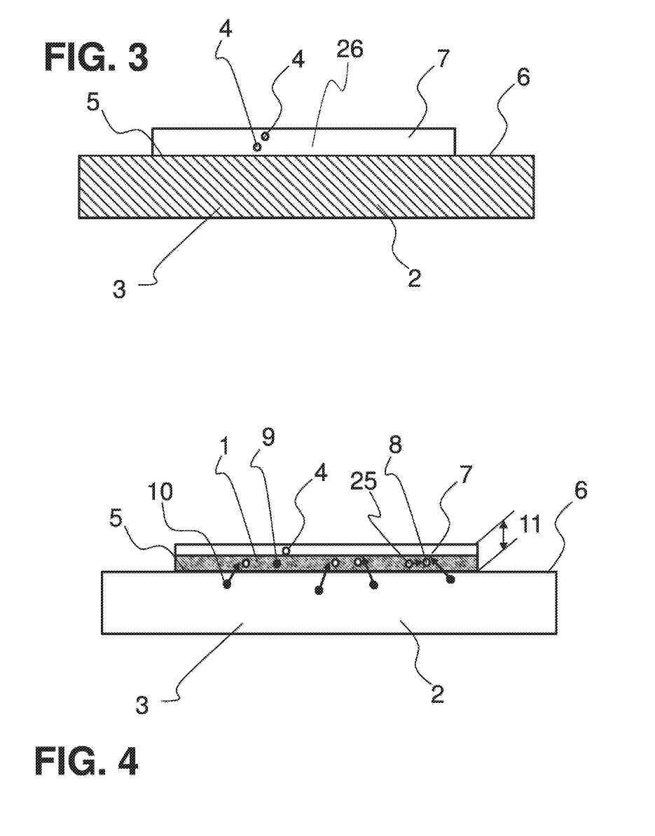

FIG. 2 shows a metal sheet 2 as per process step a) or i. The metal sheet 2 has a surface 6 and consists of a base material 3. Furthermore, a section A is shown here and this will be described in FIG. 3.

FIG. 3 shows the metal sheet 2 after process step b) or ii. The metal sheet 2 consists of a base material 3 and is provided in a subregion 5 with a surface layer 7. The surface layer 7 is arranged on the surface 6 of the metal sheet 2. The surface layer 7 includes titanium dioxide 4. In some examples, the surface layer 7 has been applied in the form of a printed paste 26 to the surface 6 by a printing process.

FIG. 4 shows the metal sheet 2 after the process step v. As a result of the heat treatment as per process step c) or v., aluminum 10 diffuses from the base material 3 into the surface layer 7. As a result, aluminum oxide 8 is formed by reaction with the oxygen 25 of the titanium dioxide 4 in the subregion 5 of the metal sheet 2 in the region of the surface layer 7 in the vicinity of the surface 6. The titanium dioxide 4 thus serves as donor of the oxygen 25 that is needed here for the conversion of aluminum 10 into aluminum oxide 8. The surface layer 7 has a thickness 11. Depending on the conditions (temperature, duration) of the heat treatment, a diffusion barrier layer 1 is formed in the surface layer 7, extending from the surface 6 in the direction of the surface layer 7. This diffusion barrier layer 1 is formed by a-aluminum oxide. As a result of the conversion of aluminum 10 into aluminum oxide 8 by the oxygen 25 of the titanium dioxide 4, this titanium dioxide 4 is converted into lower titanium oxides 9.

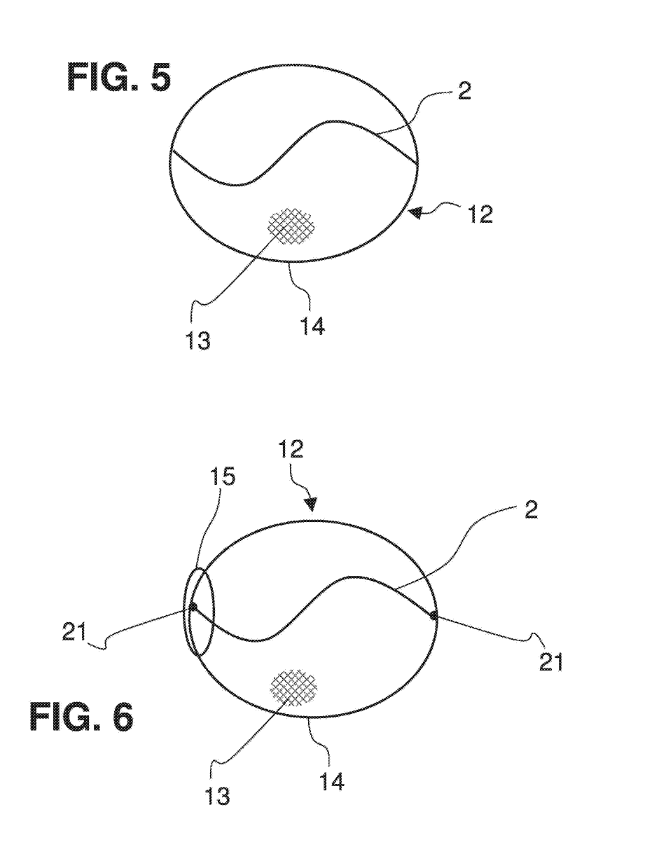

FIG. 5 shows an exhaust gas treatment unit 12 as per step iii., with a honeycomb body 13 having been produced here and the honeycomb body 13 being inserted into the housing 14. A metal sheet 2 is arranged in the honeycomb body 13. The honeycomb body 13 creates a structure through which an exhaust gas can flow and which can be used as exhaust gas treatment unit 12 in an exhaust gas line 20 of a motor vehicle 18.

FIG. 6 shows the exhaust gas treatment 12 as per step iv. of the process. Here, solder material 21 is arranged in a soldering section 15 of the honeycomb body 13 and of the housing 14. The solder material 21 is arranged at least on the metal sheet 2.

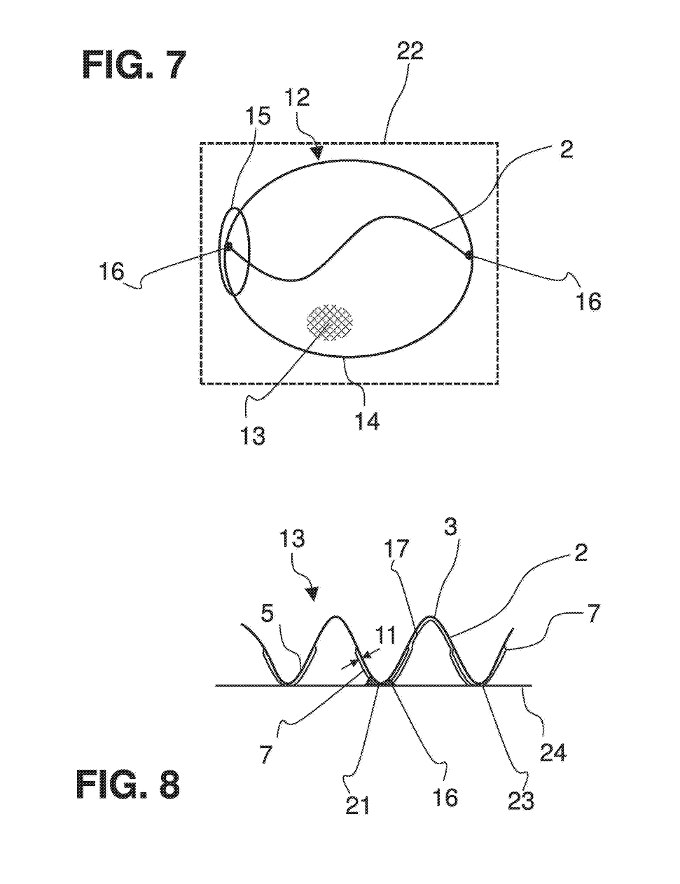

FIG. 7 shows the exhaust gas treatment unit as per process step v. The honeycomb body 13 and the housing 14 are arranged in a heat treatment apparatus 22 for carrying out the soldering process. The metal sheet 2 forms at least part of the honeycomb body 13. As a result of the soldering process, soldered connections 16 are formed at least in the soldering section 15.

FIG. 8 shows the exhaust gas treatment 12 after the process step v. The metal sheet 2 has, at least in subregions 5, a surface layer 7 having a thickness 11. The surface layer 7 is at least partly covered by an exhaust gas treatment layer 17. The surface layer 7 is arranged in the region of the contact points 23 between metal sheet 2 and component 24 so that no diffusion bond is formed between the metal sheet 2 and the component 24 of the exhaust gas treatment unit 12. The surface layer 7 is likewise present at the soldered connection 16. The soldered connection 16 is formed by solder material 21 between the metal sheet 2 and the component 24 after carrying out the soldering process.

A number of implementations have been described. Nevertheless, it will be understood that various modifications may be made without departing from the spirit and scope of the disclosure. Accordingly, other implementations are within the scope of the following claims.

A number of implementations have been described. Nevertheless, it will be understood that various modifications may be made without departing from the spirit and scope of the disclosure. Accordingly, other implementations are within the scope of the following claims.

What is claimed is:

1. A process for producing a diffusion barrier layer on a metal sheet that includes a base material containing at least iron (Fe) and chromium (Cr), the process comprises the following steps:
a) provisioning the metal sheet,
b) applying at least titanium dioxide as a surface layer to at least one subregion of a surface of the metal sheet, the base material comprising aluminum and/or aluminum oxide is additionally applied as the surface layer, and
c) performing a heat treatment above 1050° C. with the metal sheet having the surface layer, so that a diffusion barrier layer comprising aluminum oxide is formed in the surface layer in the at least one subregion, with simultaneous reduction of the titanium dioxide to form a lower titanium oxide and oxidation of aluminum diffusing out of the base material to form aluminum oxide.

2. The process of claim 1, wherein at least one of titanium dioxide and aluminum oxide is applied in powder form in step b).

3. The process of claim 1, wherein applying as per step b) is carried out using a printing process.

4. The process of claim 3, wherein the printing process is a pad printing process, screen printing process, or flexographic printing process.

5. The process of claim 1, wherein the surface layer in step b) has a thickness of not more than 0.5 microns.

6. A process for producing an exhaust gas treatment unit, where the exhaust gas treatment unit includes a honeycomb body and a housing and at least the honeycomb body or the housing comprises a metal sheet, the metal sheet consists of a base material containing at least iron (Fe) and chromium (Cr), the process comprises at least the following steps:
i. provisioning of at least one metal sheet for forming a housing or a honeycomb body,
ii. applying at least titanium dioxide to at least a subregion of a surface as surface layer to at least a subregion of a surface of the metal sheet, where aluminum is already present in the base material and/or aluminum oxide is additionally applied as surface layer,
iii. forming a honeycomb body and inserting the honeycomb body into a housing,
iv. soldering application of solder to at least the honeycomb body or the housing in at least one soldering section,
v. performing a soldering process above 1050° C. on the at least one metal sheet having the surface layer under reduced pressure or protective gas, so that:
a diffusion barrier layer comprising aluminum oxide is formed only in the at least a subregion in the surface layer with simultaneous reduction of titanium dioxide to form a lower titanium oxide and oxidation of aluminum diffusing out from the base material to form aluminum oxide, and
a soldered connection on the at least one metal sheet is formed in the at least one solder section.

7. The process of claim 6, wherein a coating process by means of which an exhaust gas treatment layer, which covers the surface layer in at least one subregion, is carried out after step v.

8. An exhaust gas treatment unit having a honeycomb body and a housing, at least the honeycomb body or the housing comprises a metal sheet and the metal sheet consists of a base material containing at least iron (Fe) and chromium (Cr), the metal sheet has, at least in a subregion, a surface layer which comprises at least a-aluminum oxide and lower titanium oxides, an exhaust gas treatment layer completely covers the surface layer at least in the subregion; and a soldered connection is formed in at least a soldering section on the metal sheet at least in the one subregion.

9. A motor vehicle (18) having at least one internal combustion engine, an exhaust gas line and an exhaust gas treatment unit as claimed in claim 8.

10. A printing paste for producing a surface layer in a process for producing a diffusion barrier layer on a metal sheet that includes a base material containing at least iron (Fe) and chromium (Cr), the printing paste contains at least titanium dioxide, the process comprises the following steps:
a) provisioning the metal sheet,
b) applying at least titanium dioxide as the surface layer to at least one subregion of a surface of the metal sheet, the base material comprising aluminum and/or aluminum oxide is additionally applied as the surface layer, and
c) performing a heat treatment above 1050° C. with the metal sheet having the surface layer, so that a diffusion barrier layer comprising aluminum oxide is formed in the surface layer in the at least one subregion, with simultaneous reduction of the titanium dioxide to form a lower titanium oxide and oxidation of aluminum diffusing out of the base material to form aluminum oxide.

11. The printing paste as claimed in claim 10, wherein the printing paste additionally contains at least aluminum or aluminum oxide.

12. A printing paste for producing a surface layer in a process for producing an exhaust gas treatment unit, where the exhaust gas treatment unit has a honeycomb body and a housing and at least the honeycomb body or the housing comprises a metal sheet and the metal sheet consists of a base material containing at least iron (Fe) and chromium (Cr), the printing paste contains at least titanium dioxide, the process comprises at least the following steps:
i. provisioning of at least one metal sheet for forming a housing or a honeycomb body,
ii. applying at least titanium dioxide to at least a subregion of a surface as surface layer to at least a subregion of a surface of the metal sheet, where aluminum is already present in the base material and/or aluminum oxide is additionally applied as surface layer,
iii. forming a honeycomb body and inserting the honeycomb body into a housing,
iv. soldering application of solder to at least the honeycomb body or the housing in at least one soldering section,
v. performing a soldering process above 1050° C. on the at least one metal sheet having the surface layer under reduced pressure or protective gas, so that:
a diffusion barrier layer comprising aluminum oxide is formed only in the at least a subregion in the surface layer with simultaneous reduction of titanium dioxide to form a lower titanium oxide and oxidation of aluminum diffusing out from the base material to form aluminum oxide, and
a soldered connection on the at least one metal sheet is formed in the at least one solder section.

13. The printing paste as claimed in claim 10, wherein the printing paste additionally contains at least aluminum or aluminum oxide.
